(19) United States
(12) Patent Application Publication
(10) Pub. No.: US 2025/0015502 A1
(43) Pub. Date: Jan. 9, 2025

(54) BROADBAND DUAL-FEED CIRCULARLY-POLARIZED ANTENNA AND ANTENNA ARRAY USING THE SAME

(71) Applicant: Alpha Networks Inc., Hsinchu (TW)

(72) Inventors: Pao-Wei Lin, Hsinchu (TW); Yao-Jen Chen, Hsinchu (TW)

(73) Assignee: Alpha Networks Inc., Hsinchu (TW)

(21) Appl. No.: 18/523,106

(22) Filed: Nov. 29, 2023

(30) Foreign Application Priority Data
Jul. 4, 2023 (TW) 112124877

(51) Int. Cl. H01Q 9/04

(52) U.S. Cl. CPC H01Q 9/0435; H01Q 9/0414; H01Q 9/0478

(57) ABSTRACT

A broadband dual-feed circularly-polarized antenna includes first, second and third substrate modules. The first substrate module includes a parasitic element, and a radiator disposed below the parasitic element. The second substrate module is stacked below the first substrate module, and is provided with first and second slots. The third substrate module is stacked below the second substrate module, and includes first and second feed lines. When the antenna operates in a transmit mode, signals fed to the first and second feed lines are electromagnetically coupled to the first and second slots, then to the radiator, and finally to the parasitic element, and the parasitic element transmits an electromagnetic wave. When the antenna operates in a receive mode, the parasitic element receives an electromagnetic wave, and the electromagnetic wave is electromagnetically coupled to the radiator, then to the first and second slots, and finally to the first and second feed lines.

### CROSS-REFERENCE TO RELATED APPLICATION

This application claims priority to Taiwanese Patent Application No. 112124877, filed on Jul. 4, 2023, and incorporated by reference herein in its entirety.

### FIELD

The disclosure relates to antenna technology, and more particularly to a broadband dual-feed circularly-polarized antenna and an antenna array using the same.

### BACKGROUND

A Ku-band low-orbit satellite system has a receive band of from 10.7 GHz to 12.7 GHz, and a transmission band of from 14.0 GHz to 14.5 GHz. A conventional antenna equipment for the Ku-band low-orbit satellite system includes a receiving antenna for receiving electromagnetic waves, and a transmitting antenna for transmitting electromagnetic waves. However, the receiving antenna and the transmitting antenna have different dimensions, and would increase a molding cost for the manufacture of the conventional antenna equipment. In addition, radio frequency signals are directly fed to a radiator of the conventional antenna equipment through a via of the conventional antenna equipment, so the conventional antenna equipment cannot operate with broadband functionality.

### SUMMARY

Therefore, an object of the disclosure is to provide a broadband dual-feed circularly-polarized antenna and an antenna array using the same. The broadband dual-feed circularly-polarized antenna can have a broad frequency band that would cover a receive band and a transmit band of a communication system.

According to an aspect of the disclosure, the broadband dual-feed circularly-polarized antenna includes a first substrate module, a second substrate module and a third substrate module. The first substrate module includes a parasitic element and a radiator. The radiator is disposed below the parasitic element, and is away from the parasitic element by a first distance. A projection of a center of the radiator on the parasitic element coincides with a center of the parasitic element. The second substrate module is stacked below the first substrate module, and is provided with a first slot and a second slot. Each of the first slot and the second slot is away from the radiator by a second distance. The third substrate module is stacked below the second substrate module, and includes a first feed line and a second feed line. The first feed line is away from the first slot by a third distance. The second feed line is away from the second slot by the third distance. When the broadband dual-feed circularly-polarized antenna operates in a transmit mode, a signal that is fed to the first feed line is sequentially and electromagnetically coupled to the first slot, the radiator and the parasitic element, a signal that is fed to the second feed line is sequentially and electromagnetically coupled to the second slot, the radiator and the parasitic element, and the parasitic element transmits an electromagnetic wave to an external environment. When the broadband dual-feed circularly-polarized antenna operates in a receive mode, the parasitic element receives an electromagnetic wave from the external environment, a portion of the electromagnetic wave that is received by the parasitic element is sequentially and electromagnetically coupled to the radiator, the first slot and the first feed line, and the other portion of the electromagnetic wave that is received by the parasitic element is sequentially and electromagnetically coupled to the radiator, the second slot and the second feed line.

According to another aspect of the disclosure, the antenna array includes a first antenna, a second antenna, a third antenna and a fourth antenna, each of which is the broadband dual-feed circularly-polarized antenna described above. The second antenna is aligned with the first antenna in a first direction, and is offset from the first antenna counterclockwise by 90 degrees in orientation. The third antenna is aligned with the second antenna in a second direction, and is offset from the second antenna counterclockwise by 90 degrees in orientation. The fourth antenna is aligned with the third antenna in the first direction, and is offset from the third antenna counterclockwise by 90 degrees in orientation.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view of an embodiment of a broadband dual-feed circularly-polarized antenna according to the disclosure.

FIG. 2 is a schematic diagram illustrating relative positions of various components of the embodiment of the broadband dual-feed circularly-polarized antenna in a Z-direction.

FIG. 3 is a top view of the embodiment of the broadband dual-feed circularly-polarized antenna.

FIG. 4 is a schematic diagram illustrating various dimensions of a first slot and a second slot of the embodiment of the broadband dual-feed circularly-polarized antenna.

FIG. 5 is a plot illustrating various scattering parameters of the embodiment of the broadband dual-feed circularly-polarized antenna.

FIG. 6 is a plot illustrating a gain of the embodiment of the broadband dual-feed circularly-polarized antenna.

FIG. 7 is a plot illustrating an axial ratio of the embodiment of the broadband dual-feed circularly-polarized antenna.

FIG. 8 is a plot illustrating radiation patterns of the embodiment of the broadband dual-feed circularly-polarized antenna at various frequencies.

FIG. 9 is a top view of an embodiment of an antenna array according to the disclosure.

FIG. 10 is a plot illustrating various scattering parameters of the embodiment of the antenna array.

FIG. 11 is a plot illustrating a gain of the embodiment of the antenna array.

FIG. 12 is a plot illustrating an axial ratio of the embodiment of the antenna array.

FIG. 13 is a plot illustrating radiation patterns of the embodiment of the antenna array at various frequencies.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

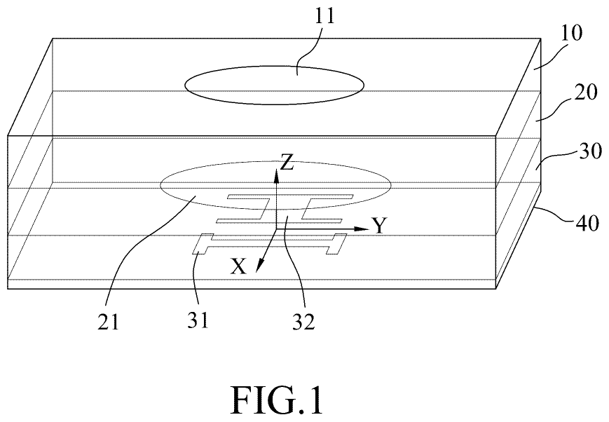

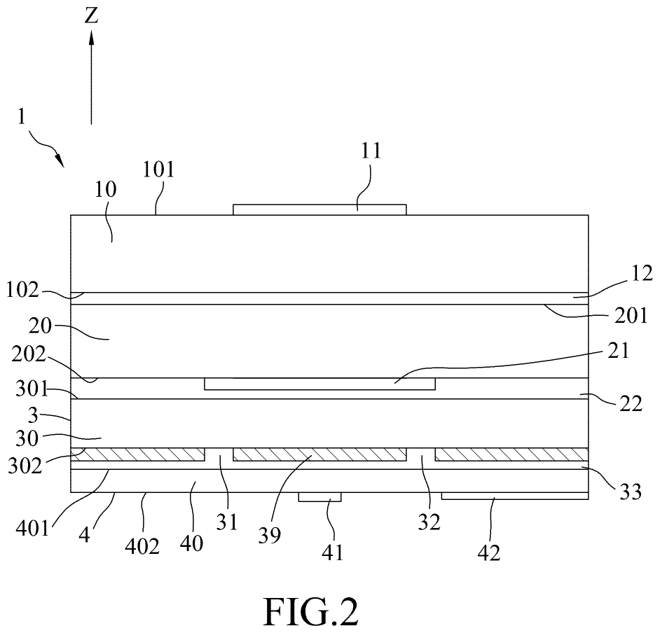

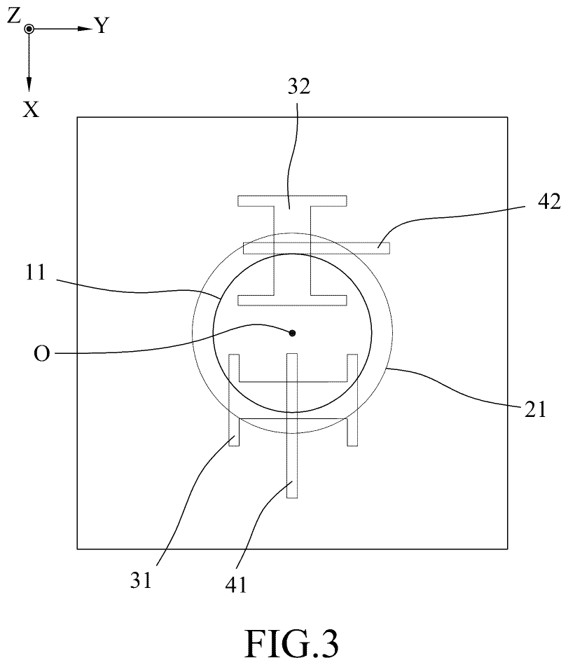

FIG. 1 is a perspective view of an embodiment of a broadband dual-feed circularly-polarized antenna according to the disclosure. FIG. 2 is a schematic diagram illustrating relative positions of various components of the broadband dual-feed circularly-polarized antenna of this embodiment in a Z-direction (also referred to as a third direction). FIG. 3 is a top view of the broadband dual-feed circularly-polarized antenna of this embodiment. Referring to FIGS. 1, 2 and 3, the broadband dual-feed circularly-polarized antenna of this embodiment includes a first substrate module 1, a second substrate module 3, a third substrate module 4 and two adhesive layers 22, 33.

The first substrate module 1 includes a first substrate 10, an adhesive layer 12 (also referred to as a first adhesive layer 12), a second substrate 20, a parasitic element 11 and a radiator 21. The radiator 21 is disposed below the parasitic element 11, and is away from the parasitic element 11 by a first distance. Each of the parasitic element 11 and the radiator 21 has a circular shape. A projection of a center of the radiator 21 on the parasitic element 11 coincides with a center (O) of the parasitic element 11. The radiator 21 has a diameter of λ/2, where λ denotes a reciprocal of a dielectric center frequency of the first substrate 10. In this embodiment, the parasitic element 11 has a radius of, for example, 2.2 mm, and the radiator 21 has a radius of, for example, 2.8 mm. The first substrate 10 has a first surface 101 on which the parasitic element 11 is disposed, and a second surface 102. In this embodiment, the first substrate 10 has a thickness of, for example, 1.2 mm, and a dielectric coefficient of, for example, 3.55. The second substrate 20 has a first surface 201 which faces the second surface 102 of the first substrate 10, and a second surface 102 on which the radiator 21 is disposed. In this embodiment, the second substrate 20 has a thickness of, for example, 1.2 mm, and a dielectric coefficient of, for example, 3.55. The first adhesive layer 12 adheres the second surface 102 of the first substrate 10 to the first surface 201 of the second substrate 20. In this embodiment, the first adhesive layer 12 has a thickness of, for example, 0.05 mm, and a dielectric coefficient of, for example, 3.5. Therefore, in this embodiment, the first distance is equal to a distance between the first surface 101 of the first substrate 10 and the second surface 202 of the second substrate 20 (i.e., 2.45 mm), which is close to a target value (e.g., 2.4 mm) of the first distance. In a modification of this embodiment, a combination of the first substrate 10, the first adhesive layer 12 and the second substrate 20 can be replaced by a substrate that has a thickness of 2.4 mm.

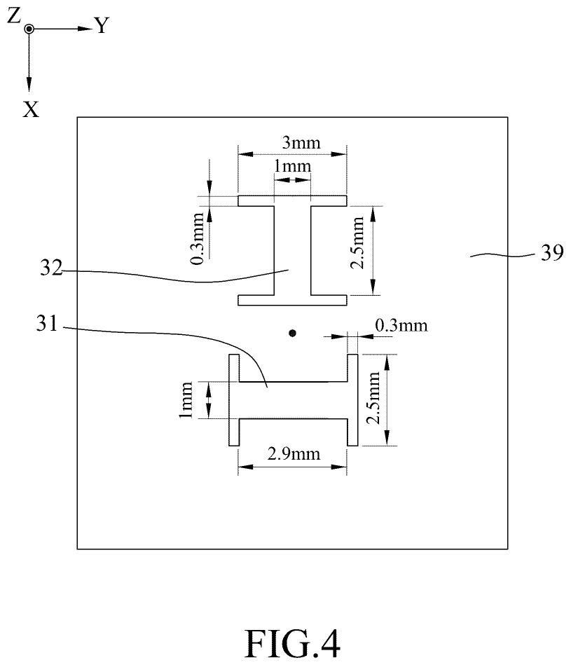

The second substrate module 3 is stacked below the first substrate module 1, and includes a third substrate 30 and a conductive layer 39. The third substrate 30 has a first surface 301 that faces the first substrate module 1, and a second surface 302. The conductive layer 39 is disposed on the second surface 302 of the third substrate 30, and is formed with a first slot 31 and a second slot 32. Each of the first slot 31 and the second slot 32 is away from the radiator 21 by a second distance. In this embodiment, the third substrate 30 has a thickness of, for example, 1 mm, and a dielectric coefficient of, for example, 3. The adhesive layer 22 (also referred to as the second adhesive layer 22) bonds the second substrate 20, the radiator 21 and the third substrate 30 together. In this embodiment, the second adhesive layer 22 has a thickness of, for example, 0.05 mm, and a dielectric coefficient of, for example, 3.5. Therefore, in this embodiment, the second distance is equal to a distance between the radiator 21 and the second surface 302 of the third substrate 30 (i.e., about 1.05 mm), which is close to the thickness of the third substrate 30 (i.e., 1 mm). The conductive layer 39 is made of metal. Each of the first slot 31 and the second slot 32 has an H shape. The first slot 31 serves as a horizontal slot, and two side portions thereof extend in an X-direction (also referred to as a first direction). The second slot 32 serves as a vertical slot, and two side portions thereof extend in a Y-direction (also referred to as a second direction). In this embodiment, exemplary values of various dimensions of the first slot 31 and the second slot 32 are shown in FIG. 4.

The third substrate module 4 is stacked below the second substrate module 3, and includes a fourth substrate 40, a first feed line 41 and a second feed line 42. The first feed line 41 is away from the first slot 31 by a third distance. The second feed line 42 is away from the second slot 32 by the third distance. The fourth substrate 40 has a first surface 401 which faces the second substrate module 3, and a second surface 402 on which the first feed line 41 and the second feed line 42 are disposed. The adhesive layer 33 (also referred to as the third adhesive layer 33) bonds the third substrate 30, the conductive layer 39 and the fourth substrate 40 together. In this embodiment, the third adhesive layer 33 has a thickness of, for example, 0.05 mm and a dielectric coefficient of, for example, 3.5, and the fourth substrate 40 has a thickness of, for example, 0.15 mm and a dielectric coefficient of, for example, 3. Therefore, in this embodiment, the third distance is equal to a distance between the conductive layer 39 and the second surface 402 of the fourth substrate 40 (i.e., about 0.2 mm), which is not smaller than the thickness of the fourth substrate 40 (i.e., 0.15 mm). The first feed line 41 serves as a vertical feed line, and is a microstrip line that extends in the X-direction. The second feed line 42 serves as a horizontal feed line, and is a microstrip line that extends in the Y-direction. In this embodiment, each of the first feed line 41 and the second feed line has a length of, for example, 4 mm, and a width of, for example, 0.35 mm.

When the broadband dual-feed circularly-polarized antenna of this embodiment operates in a transmit mode, a signal that is fed to the first feed line 41 is sequentially and electromagnetically coupled to the first slot 31, the radiator 21 and the parasitic element 11, a signal that is fed to the second feed line 42 is sequentially and electromagnetically coupled to the second slot 32, the radiator 21 and the parasitic element 11, and the parasitic element 11 transmits an electromagnetic wave to an external environment.

When the broadband dual-feed circularly-polarized antenna of this embodiment operates in a receive mode, the parasitic element 11 receives an electromagnetic wave from the external environment, a portion of the electromagnetic wave that is received by the parasitic element 11 is sequentially and electromagnetically coupled to the radiator 21, the first slot 31 and the first feed line 41, and the other portion of the electromagnetic wave that is received by the parasitic element 11 is sequentially and electromagnetically coupled to the radiator 21, the second slot 32 and the second feed line 42.

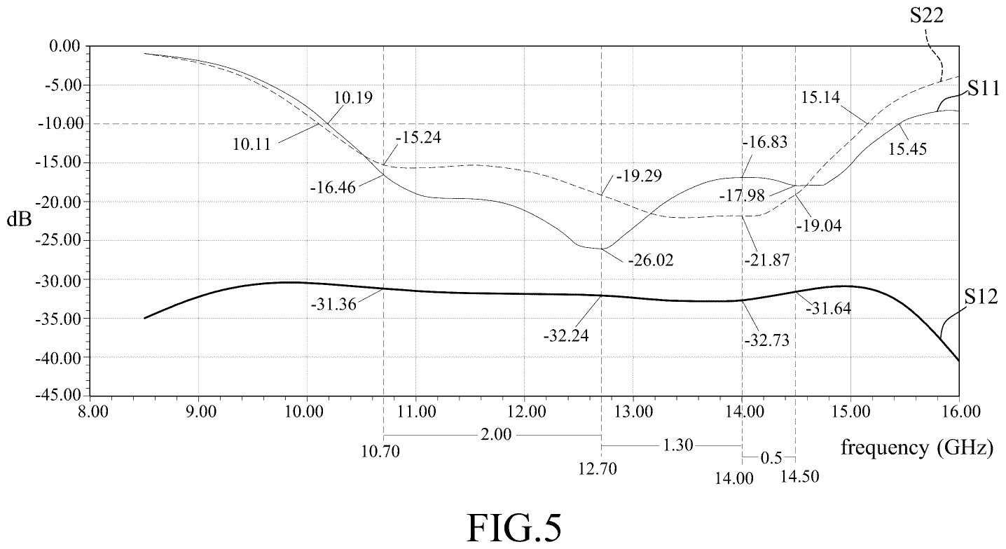

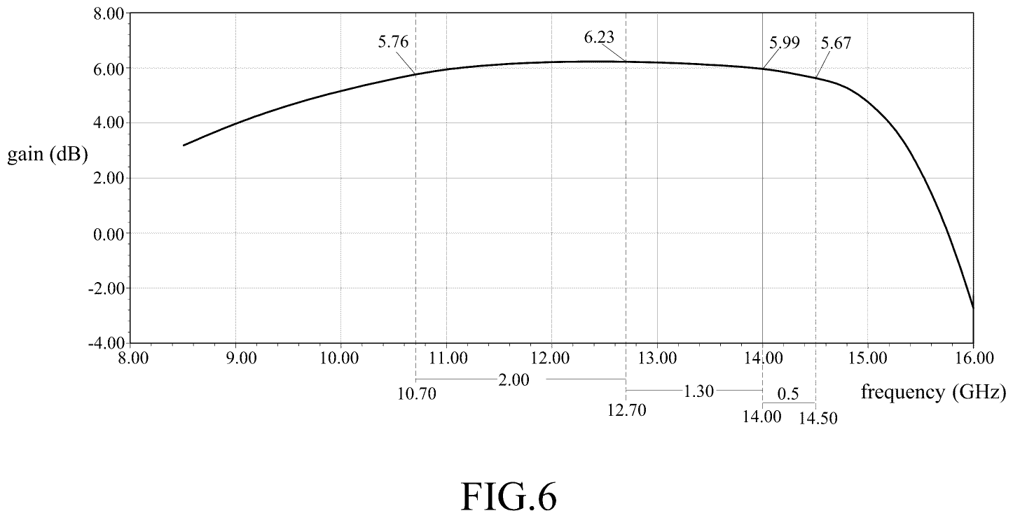

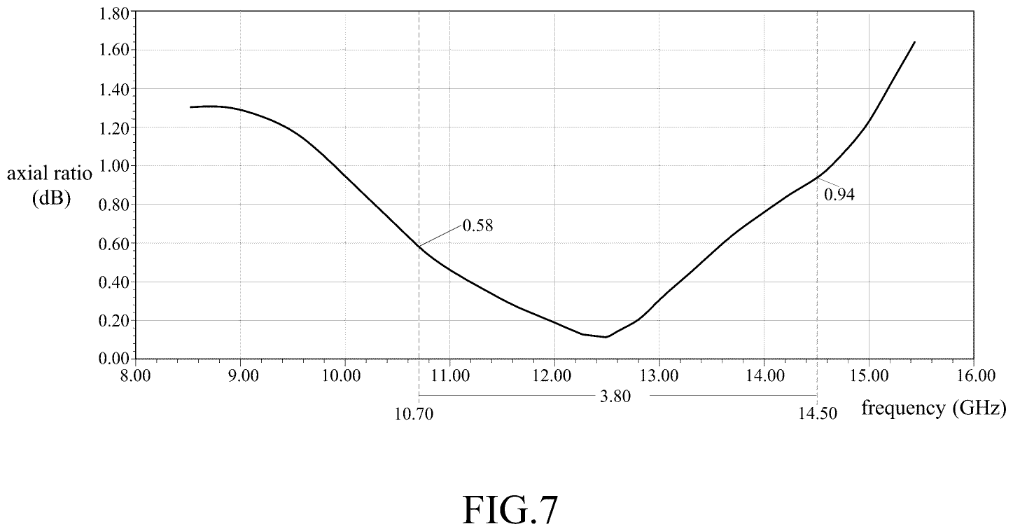

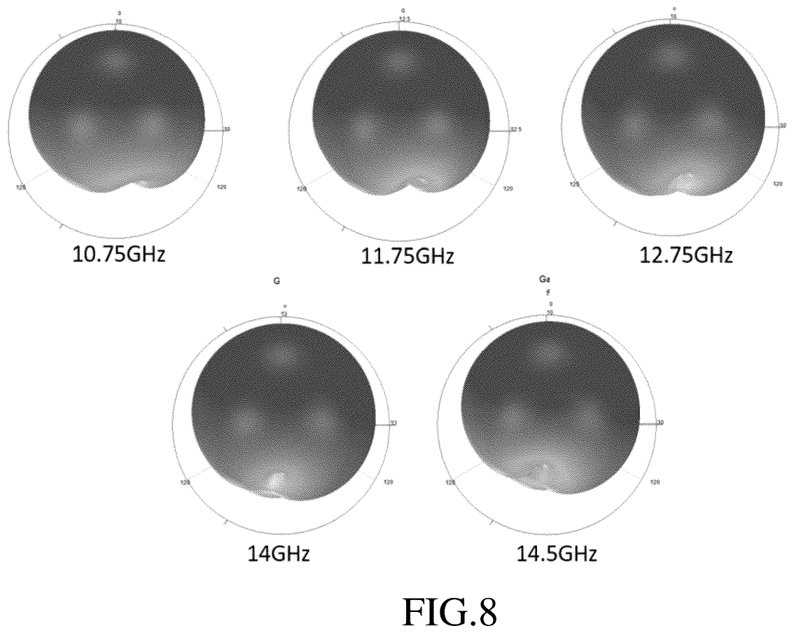

FIG. 5 is a plot illustrating scattering parameters (S11, S22, S12) of the broadband dual-feed circularly-polarized antenna of this embodiment in a frequency range of from 8 GHz to 16 GHz. Referring to FIGS. 3 and 5, the scattering parameter (S11) is a reflection coefficient at the first feed line 41, and is smaller than a target value (e.g., −10 dB) of the scattering parameter (S11) in a receive band of from 10.7 GHz to 12.7 GHz and a transmit band of from 14.0 GHz to 14.5 GHz of a Ku-band low-orbit satellite system. The scattering parameter (S22) is a reflection coefficient at the second feed line 42, and is smaller than a target value (e.g., −10 dB) of the scattering parameter (S22) in the receive band and the transmit band. The scattering parameter (S12) is related to isolation between the first feed line 41 and the second feed line 42, and is smaller than a target value (e.g., −25 dB) of the scattering parameter (S22) in the receive band and the transmit band. FIG. 6 is a plot illustrating a gain of the broadband dual-feed circularly-polarized antenna of this embodiment in the frequency range of from 8 GHz to 16 GHz. Referring to FIG. 6, the gain is close to a target value (e.g., 6 dB) thereof in the receive band and the transmit band. FIG. 7 is a plot illustrating an axial ratio of the broadband dual-feed circularly-polarized antenna of this embodiment in the frequency range of from 8 GHz to 16 GHz. Referring to FIG. 7, the axial ratio is smaller than a target value (e.g., 1 dB) thereof in a frequency band of from 10.7 GHz to 14.5 GHz. Radiation patterns of the broadband dual-feed circularly-polarized antenna of this embodiment at frequencies of 10.75 GHz, 11.75 GHz, 12.75 GHz, 14 GHz and 14.5 GHz are shown in FIG. 8.

Referring back to FIGS. 1, 2 and 3, in view of the above, the broadband dual-feed circularly-polarized antenna of this embodiment has the following advantages: (a) the coupling between the parasitic element 11 and the radiator 21 can widen a bandwidth of the broadband dual-feed circularly-polarized antenna, so the broadband dual-feed circularly-polarized antenna can have a broad frequency band that would cover a receive band and a transmit band of a communication system; (b) the dual-feed structure (including the first feed line 41 and the second feed line 42) can realize circular polarization; and (c) the coupling between the multi-layered structure (including the first substrate 10, the second substrate 20, the third substrate 30 and the fourth substrate 40) and the dual-feed structure is beneficial to further widening the bandwidth of the broadband dual-feed circularly-polarized antenna.

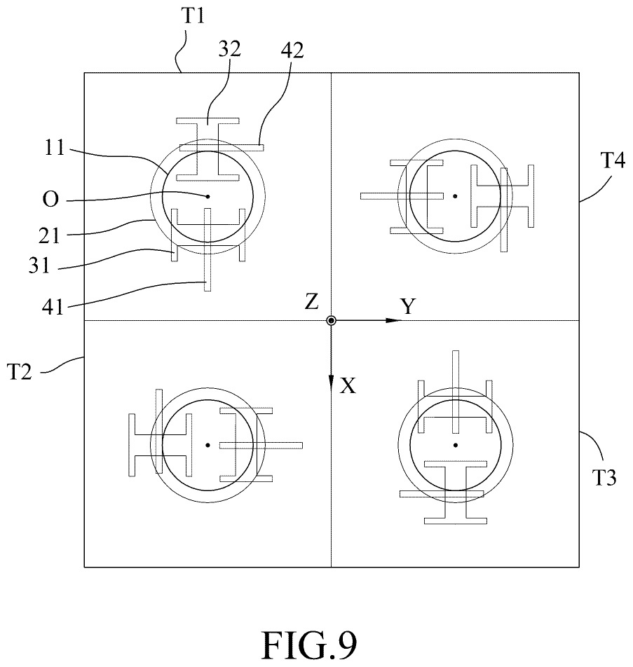

FIG. 9 is a top view of an embodiment of an antenna array according to the disclosure. Referring to FIG. 9, the antenna array of this embodiment includes a number (M×N) of antennas, where M≥1 and N≥1. FIG. 9 depicts an example where M=2 and N=2. In the example depicted in FIG. 9, the antenna array includes a first antenna (T1), a second antenna (T2), a third antenna (T3) and a fourth antenna (T4), each of which is the broadband dual-feed circularly-polarized antenna described above. The second antenna (T2) is aligned with the first antenna (T1) in the X-direction, and is offset from the first antenna (T1) counterclockwise by 90 degrees in orientation. The third antenna (T3) is aligned with the second antenna (T2) in the Y-direction, and is offset from the second antenna (T2) counterclockwise by 90 degrees in orientation (i.e., being offset from the first antenna (T1) counterclockwise by 180 degrees in orientation). The fourth antenna (T4) is aligned with the third antenna (T3) in the X-direction, and is offset from the third antenna (T3) counterclockwise by 90 degrees in orientation (i.e., being offset from the first antenna (T1) counterclockwise by 270 degrees in orientation).

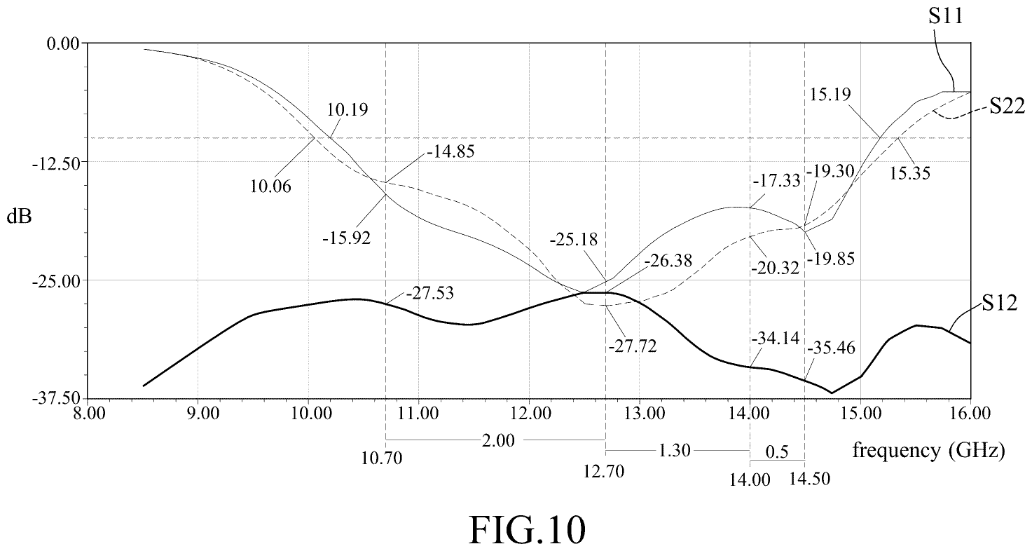

FIG. 10 is a plot illustrating scattering parameters (S11, S22, S12) of the antenna array of this embodiment in a frequency range of from 8 GHz to 16 GHz. Referring to FIGS. 9 and 10, the scattering parameter (S11) is a reflection coefficient at the first feed line 41 of the first antenna (T1), and is smaller than a target value (e.g., −10 dB) of the scattering parameter (S11) in a receive band of from 10.7 GHz to 12.7 GHz and a transmit band of from 14.0 GHz to 14.5 GHz of a Ku-band low-orbit satellite system. The scattering parameter (S22) is a reflection coefficient at the second feed line 42 of the first antenna (T1), and is smaller than a target value of (e.g., −10 dB) of the scattering parameter (S22) in the receive band and the transmit band. The scattering parameter (S12) is related to isolation between the first feed line 41 and the second feed line 42 of the first antenna (T1), and is smaller than a target value (e.g., −25 dB) of the scattering parameter (S12) in the receive band and the transmit band.

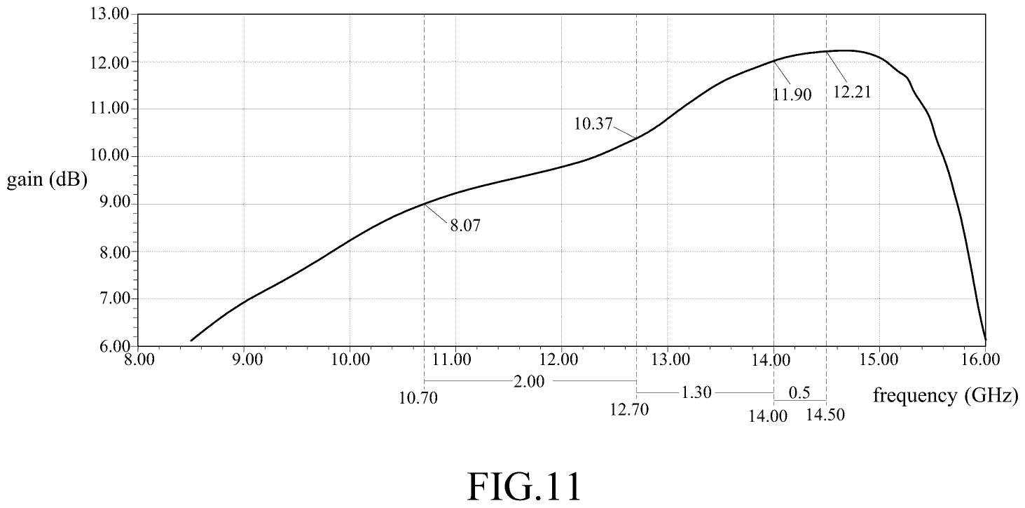

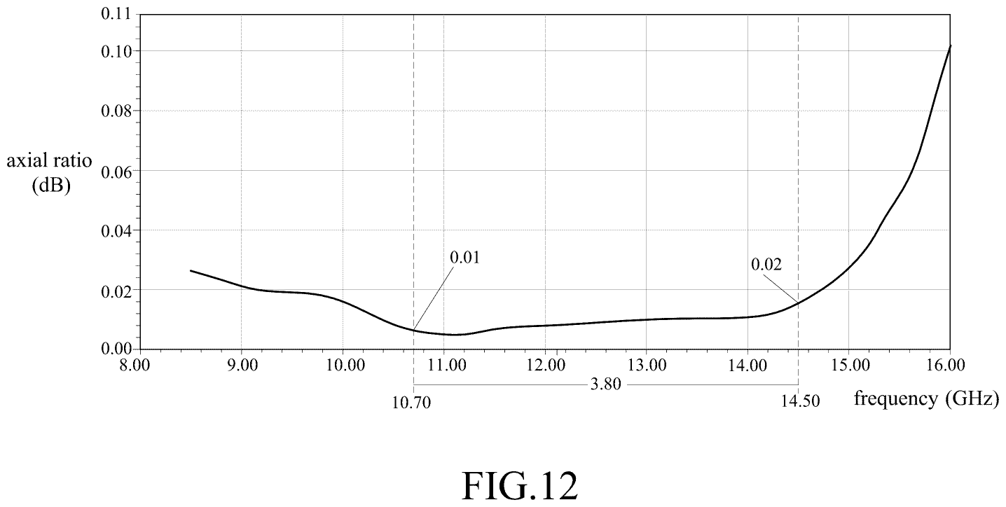

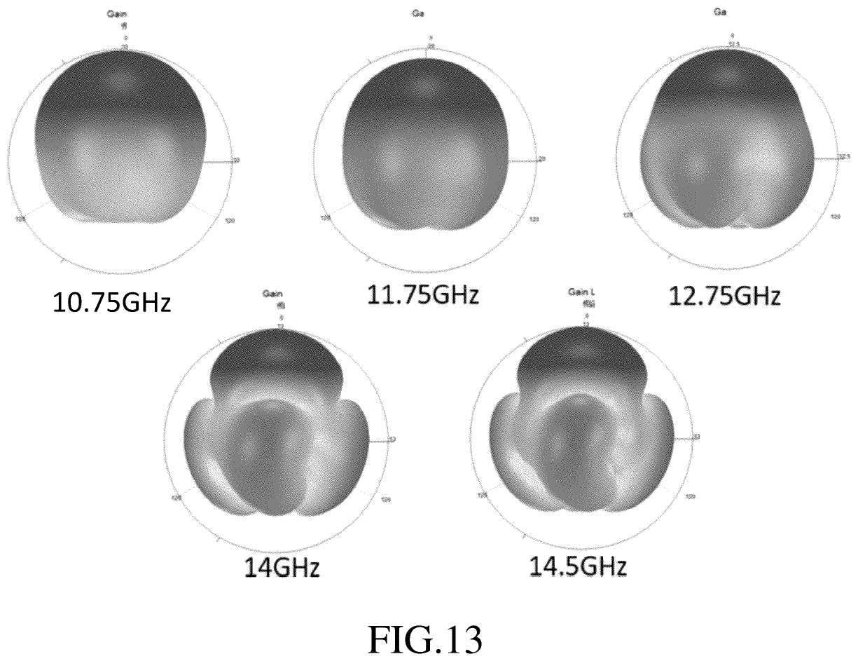

FIG. 11 is a plot illustrating a gain of the antenna array of this embodiment in the frequency range of from 8 GHz to 16 GHz. Referring to FIG. 11, the gain is greater than a target value (e.g., 6 dB) thereof in the receive band and the transmit band. FIG. 12 is a plot illustrating an axial ratio of the antenna array of this embodiment in the frequency range of from 8 GHz to 16 GHz. Referring to FIG. 12, the axial ratio is smaller than a target value (e.g., 1 dB) thereof in a frequency band of from 10.7 GHz to 14.5 GHz. It can be reasonably determined from FIGS. 7 and 12 that, in the frequency band of from 10.7 GHz to 14.5 GHz, the axial ratio of the antenna array of this embodiment (not greater than 0.02 dB) is smaller than the axial ratio of the broadband dual-feed circularly-polarized antenna shown in FIGS. 1, 2 and 3, i.e., the antenna array of this embodiment has better circular polarization than the broadband dual-feed circularly-polarized antenna shown in FIGS. 1, 2 and 3. Radiation patterns of the antenna array of this embodiment at frequencies of 10.75 GHz, 11.75 GHz, 12.75 GHz, 14 GHz and 14.5 GHz are shown in FIG. 13.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A broadband dual-feed circularly-polarized antenna comprising:
a first substrate module including a parasitic element and a radiator, said radiator being disposed below said parasitic element, and being away from said parasitic element by a first distance, a projection of a center of said radiator on said parasitic element coinciding with a center of said parasitic element;
a second substrate module stacked below said first substrate module, and provided with a first slot and a second slot, each of the first slot and the second slot being away from said radiator by a second distance; and
a third substrate module stacked below said second substrate module, and including a first feed line and a second feed line, said first feed line being away from the first slot by a third distance, said second feed line being away from the second slot by the third distance;
wherein, when said broadband dual-feed circularly-polarized antenna operates in a transmit mode, a signal that is fed to said first feed line is sequentially and electromagnetically coupled to the first slot, said radiator and said parasitic element, a signal that is fed to the second feed line is sequentially and electromagnetically coupled to the second slot, said radiator and said parasitic element, and said parasitic element transmits an electromagnetic wave to an external environment;
wherein, when said broadband dual-feed circularly-polarized antenna operates in a receive mode, said parasitic element receives an electromagnetic wave from the external environment, a portion of the electromagnetic wave that is received by said parasitic element is sequentially and electromagnetically coupled to said radiator, the first slot and said first feed line, and the other portion of the electromagnetic wave that is received by said parasitic element is sequentially and electromagnetically coupled to said radiator, the second slot and said second feed line.

2. The broadband dual-feed circularly-polarized antenna as claimed in claim 1, wherein:
said first substrate module further includes a first substrate and a second substrate;
said first substrate has a first surface on which said parasitic element is disposed, and a second surface; and
said second substrate has a first surface which faces said second surface of said first substrate, and a second surface on which said radiator is disposed.

3. The broadband dual-feed circularly-polarized antenna as claimed in claim 2, wherein:
said first substrate module further includes a first adhesive layer;
said first adhesive layer adheres said second surface of said first substrate to said first surface of said second substrate; and
a distance between said first surface of said first substrate and said second surface of said second substrate is equal to the first distance.

4. The broadband dual-feed circularly-polarized antenna as claimed in claim 1, wherein:
said second substrate module includes a third substrate and a conductive layer;
said third substrate has a first surface that faces said first substrate module, and a second surface;
said conductive layer is disposed on said second surface of said third substrate, and is formed with the first slot and the second slot; and
a distance between said radiator and said second surface of said third substrate is equal to the second distance.

5. The broadband dual-feed circularly-polarized antenna as claimed in claim 1, wherein:
said third substrate module further includes a fourth substrate;
said fourth substrate has a first surface which faces said second substrate module, and a second surface on which said first feed line and said second feed line are disposed; and
said fourth substrate has a thickness not greater than the third distance.

6. The broadband dual-feed circularly-polarized antenna as claimed in claim 1, further comprising a second adhesive layer that bonds said first substrate module and said second substrate module together.

7. The broadband dual-feed circularly-polarized antenna as claimed in claim 1, further comprising a third adhesive layer that bonds said second substrate module and said third substrate module together.

8. The broadband dual-feed circularly-polarized antenna as claimed in claim 1, wherein each of said parasitic element and said radiator has a circular shape.

9. The broadband dual-feed circularly-polarized antenna as claimed in claim 1, wherein:
each of the first slot and the second slot has an H shape;
two side portions of the first slot extend in a first direction;
two side portions of the second slot extend in a second direction;
said first feed line is a microstrip line that extends in the first direction; and
said second feed line is a microstrip line that extends in the second direction.

10. An antenna array comprising:
a first antenna, a second antenna, a third antenna and a fourth antenna, each of which is a broadband dual-feed circularly-polarized antenna according to claim 1;
wherein said second antenna is aligned with said first antenna in a first direction, and is offset from said first antenna counterclockwise by 90 degrees in orientation;
wherein said third antenna is aligned with said second antenna in a second direction, and is offset from said second antenna counterclockwise by 90 degrees in orientation; and
wherein said fourth antenna is aligned with said third antenna in the first direction, and is offset from said third antenna counterclockwise by 90 degrees in orientation.
